(19) United States
(12) Patent Application Publication
(10) Pub. No.: US 2004/0141820 A1
(43) Pub. Date: Jul. 22, 2004

(54) Debris catching device for abrasive and cutting tools

(76) Inventors: David H. Mikon, Woodland Hills, CA (US); David M. Wild, Woodland Hills, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/733,653

(22) Filed: Dec. 10, 2003

Related U.S. Application Data
(60) Provisional application No. 60/435,383, filed on Dec. 20, 2002.

(51) Int. Cl. B23B 45/00

(52) U.S. Cl. 408/67

(57) ABSTRACT

A debris catching device for abrasion or cutting tools, such as hole saw apparatuses, includes a generally dome-shaped body constructed of a resiliently flexible material. Preferably, the material is non-marking and transparent or translucent. A lip extends from an upper rim of the body, which defines an open-ended cavity which is sized so as to substantially surround an abrasion or cutting tool, such as a hole saw. An aperture formed through the body generally opposite the opening of the cavity is configured to receive a pertinent member of the tool. As a hole is cut through the working surface with a hole saw, for example, debris is captured within the cavity of the body.

### RELATED APPLICATION

Priority is claimed to Provisional Patent Application Serial No. 60/435,383, filed Dec. 20, 2002.

### BACKGROUND OF THE INVENTION

The present invention generally relates to cutting tools and the like. More particularly, the present invention is related to a debris catching device for such abrasive tools and devices, such as hole saws and drills.

There are many instances in which a hole must be cut or drilled into a surface. For example, electricians cut holes for cable, conduit, recessed light fixtures, etc. Plumbers cut holes for installing piping and sprinkler heads. Audio/video installers may require holes through walls, ceilings, or floors for cable, cameras, or speakers. HVAC requires holes for vents, ducting, and finish grills. Such holes are cut through cement, wood, and more commonly drywall, plaster and ceiling acoustic tiles.

As can be imagined, particularly when cutting holes through a ceiling, there is a great deal of dust and debris generated when cutting such holes. In the past, this has required the placement of tarps or blankets underlying the intended hole for capturing the debris, particularly in a finished home. The dust from the plaster or drywall tended to travel and coat surrounding furniture or carpeting. Such set-up and cleaning required a significant amount of time on behalf of the trade person. Additionally, while cutting the hole, there existed the possibility of debris flying into the face or even eyes of the worker. Due to the proximity of the construction worker to the hole being cut, the construction worker often inhaled dust particles generated during the cutting of the hole.

In an attempt to alleviate some of these problems, many trade people resorted to extreme measures to capture the dust and debris while cutting such holes. Many household items have been experimented with in the past in order to capture the dust and debris. For example, a plastic garbage bag would be placed over the area of the hole and a hole saw and drill would be inserted through the garbage bag. Other methods included the use of cardboard boxes, balls, or milk cartons having the bottom thereof removed. However, these methods presented various disadvantages. First, they were all relatively awkward in use. Also, their effectiveness at capturing the dust and particles generated during the cutting of the hole was limited. Second, many of these objects were comprised of a material which could mar or scratch the working surface. Lastly, the electrician or other trade person could not see the hole saw nor the hole being drilled during the cutting process.

In response to this need, there have been at least two products which have been introduced commercially. The Qwik Cutter™ comprises a hole saw having specialized cutting blades and a stabilizing spring forming an assembly which is attached to a drill by a dedicated pilot bit and arbor. The hole saw assembly is packaged in a clear plastic which can be used as a dust catcher. However, this device presents many drawbacks. First, a trade person would need to purchase a specific cutting blade and stabilizing spring assembly, which is inefficient and difficult to use as compared to hole saws. Such would render the trade person's existing inventory of hole saws essentially worthless. Secondly, the rather thin and brittle plastic used in the packaging for this device and which can be used as a catcher is not resilient and requires the manual depression by the trade person's fingers in order to move the walls of the catcher back into its original shape. Due to the nature of the plastic used, the catcher is prone to cracking and thus has a very limited life.

Another hole cutter assembly (the Elco Adjustable round hole cutter™) includes a rigid plastic dust catcher. However, the actual device used to cut the holes is very complicated and includes a compression spring, specialized cutting bits, a lock-nut, a counter-balance, and set screws. The device must be readjusted by altering the lock-nut or set screws and the compression spring to accommodate the depth of the material to be cut due to the rigid nature of the catcher, which does not allow the end of the drill to brought towards the ceiling or wall. Thus, the depth of the material which can be cut is limited. Also, different specialized blades must be purchased for each sized hole to be cut and material to be cut. Once again, this renders the existing inventory of hole saws owned by the trade person worthless. Aside from being complicated in use, this device is very expensive.

Accordingly, there is a continuing need for a device for capturing debris and dust generated while cutting holes through ceilings, walls, inclined surfaces, or even floors. The device should be relatively simple in use and inexpensive. The device should also be able to be used with the existing inventory of hole saws owned by the trade person. The present invention fulfills these needs and provides other related advantages.

### SUMMARY OF THE INVENTION

The present invention resides in a device which is designed to capture debris during the cutting of holes, such as with hole saws and the like. The device is simple in use and inexpensive and allows the trade person to use his existing inventory of hole saws.

Generally, the debris catching device comprises a resiliently flexible body having an upper rim which is adapted to rest generally flush with the working surface. The body defines an open-ended cavity which is configured to substantially surround the hole saw or cutting tool. In a particularly preferred embodiment, a lip or flange extends outwardly from the rim to seal against the working surface and prevent debris from escaping from the gap between the body and the working surface.

An aperture is formed through the body generally opposite the opening of the cavity. The aperture is configured to receive a lower portion of the cutting apparatus therethrough. In a particularly preferred embodiment, the aperture is configured to receive an arbor of a hole saw or pilot bit of a hole saw assembly therethrough. In a particularly preferred embodiment, means are provided for reinforcing the aperture.

As a hole is cut through the working surface with the hole saw, the body can be depressed towards the working surface to insure that the hole is cut to the proper depth. During this process, the debris is captured within the cavity of the body.

The body is typically of a dome-shape. In one embodiment, the body is generally hemispherical in shape. In another, the body is generally an open-ended cone to accommodate hole saws, bits, or the like of a greater length.

The body is preferably comprised of being non-marking and transparent or translucent material so that the trades person can view the area to be cut. Such a material is UVA vinyl acetate.

A vacuum port may be formed in the body and configured for removable connection to a vacuum hose. This allows the debris and dust to be removed during the cutting process to increase the visibility of the cutting process and, in some instances, protect the trades person from harmful debris.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a top perspective view of a debris catching device embodying the present invention;

FIG. 2 is a top perspective view of the debris catching device of FIG.1, having a hole saw apparatus operably associated therewith;

FIG. 3 is a bottom perspective view of the debris catching device of the present invention placed against a ceiling working surface;

FIG. 4 is a bottom perspective view illustrating the drill of the hole saw apparatus being pushed upwardly into the ceiling to create the hole, causing the debris catching device to be pushed upwardly and deformed;

FIG. 5 is a bottom perspective view similar to FIG. 3, but illustrating the creation of a hole in the ceiling as the debris catching device and hole saw apparatuses is removed therefrom with the device returned to its original shape;

FIG. 6 is a cross-sectional view of the debris catching device placed against a working surface and having a hole saw disposed therein;

FIG. 7 is a cross-sectional view similar to FIG. 6, illustrating the movement of the hole saw into the working surface to create a hole in the debris being caught within the debris catching device;

FIG. 8 is a cross-sectional view illustrating the removal of the debris catching device and hole saw from the working surface, illustrating the debris from the hole being maintained in the debris catching device;

FIG. 9 is a bottom perspective view of another debris catching device embodying the present invention particularly adapted for use in cutting holes in corners;

FIG. 10 is a bottom perspective view of the debris catching device of FIG. 9 having a hole saw apparatus associated therewith for cutting a hole in the corner of a ceiling;

FIG. 11 is a top perspective view of another debris catching device embodying the present invention and particularly adapted for elongated drill bits and hole saws;

FIG. 12 is a side perspective view of the debris catching device of FIG. 11;

FIG. 13 is a perspective view of a debris catching device embodying the present invention and having a vacuum port formed therein; and

FIG. 14 is a cross-sectional schematic view illustrating the debris catching device of FIG. 13 with a vacuum hose attached thereto for removing debris therefrom.

### DETAILED DESCRIPTION OF THE PREFERRED EMBODIMENTS

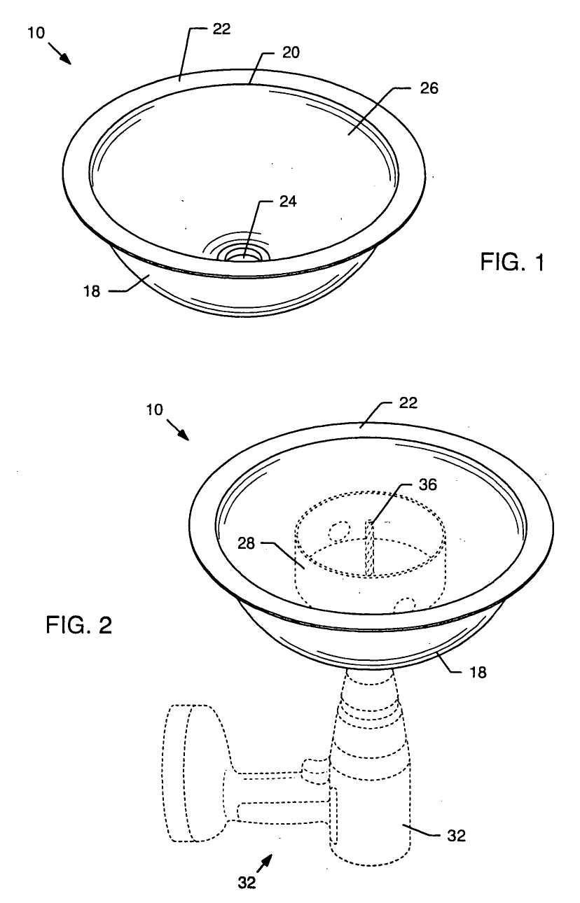

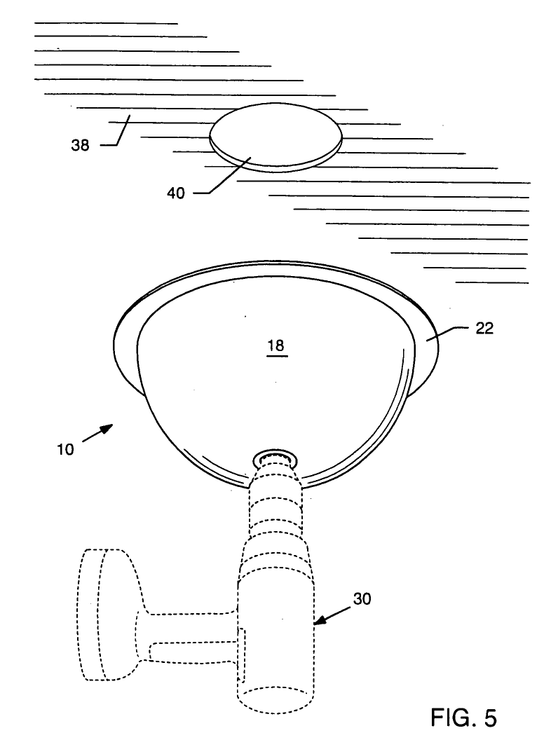

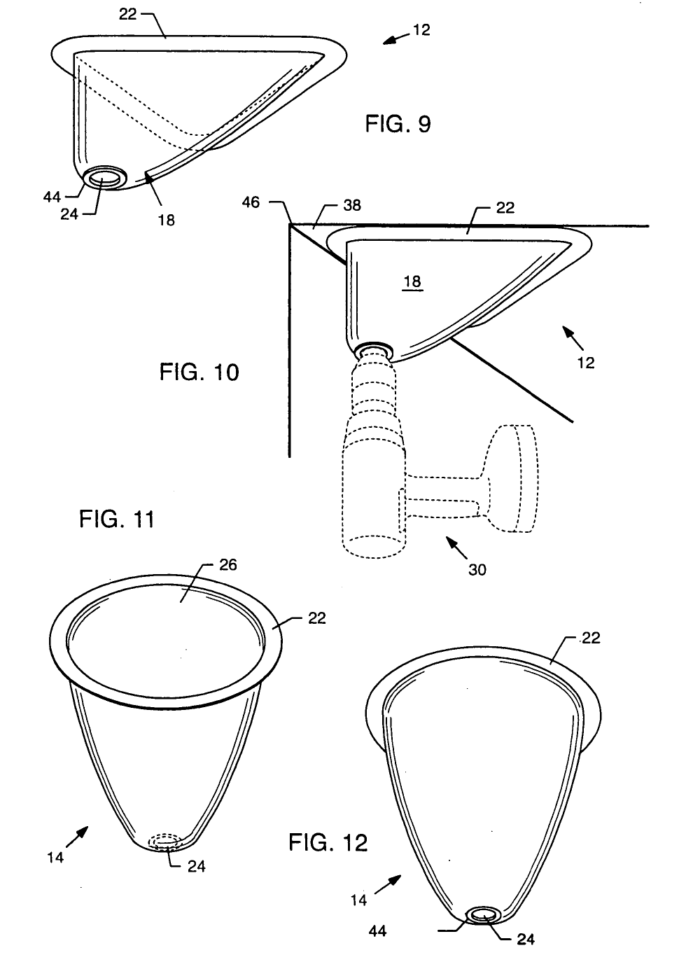

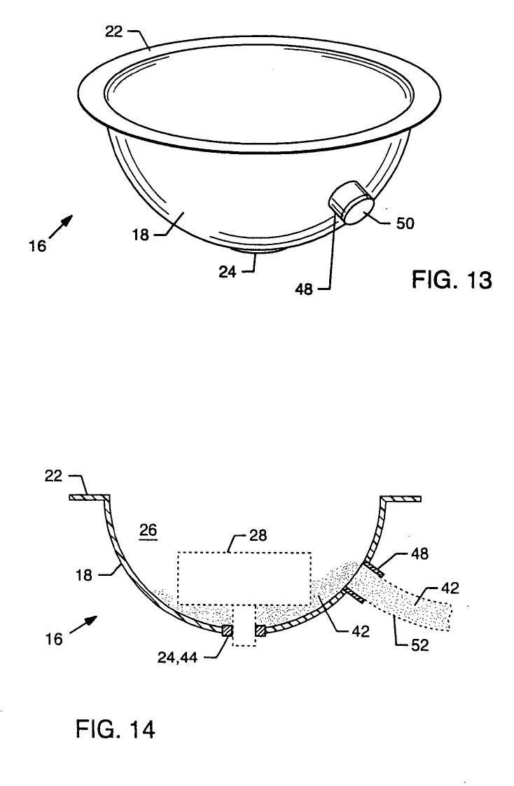

As shown in the accompanying drawings for purposes of illustration, the present invention resides in a device which is particularly designed for capturing debris from hole saws and the like. The device is generally referred to by the reference number 10 in FIGS. 1-8, by the reference number 12 in FIGS. 9 and 10, by the reference number 14 in FIGS. 11 and 12, and by the reference number 16 in FIGS. 13 and 14. As will be more fully described herein, the device 10-16 enables a trades person to utilize his or her existing inventory of drills, drill bits and hole saws and permits the trades person to cut holes in the working surface in a conventional manner without having to expend time in preparing the area surrounding the hole and cleaning after the procedure.

With reference to FIGS. 1 and 2, a particularly preferred embodiment of the device 10 is illustrated. The debris catching device 10 is manufactured by existing molding techniques using a resiliently flexible material, such as UVA vinyl acetate of 50 shore or other resiliently flexible material meeting the needs of the present invention. The device 10 has a resiliently flexible body 18 having an upper rim 20 defining an open end. Preferably, a lip or flange 22 extends outward from the rim 20 to provide a better seal against the working surface, as will be more fully described herein. An aperture 24 is formed in the body 18 generally opposite the open end thereof.

The body 18 is sufficiently large so that the cavity 26 formed therein can accommodate a hole saw 28 or drill bit 36 of a hole saw apparatus 30. Such hole saw apparatuses 30 typically include a power device in the form of a drill 32 having a chuck 34 which is operably connected to the hole saw 28 and a drill bit 36. The drill 32 may be directly connected to the drill bit 36, or an arbor of the hole saw 28. The hole saw 28, drill bit 36 and any arbor extending downwardly from the hole saw is generally referred to as the hole saw assembly herein. As is well-known in the art, the drill bit 36 serves to create a pilot hole in the working surface for guiding the placement of the hole saw 28 to create the intended circular hole in the ceiling, wall, or other working surface.

The device 10 illustrated in FIGS. 1-8 has a dome-shaped body 18 in the form of a hemisphere. In a particularly preferred embodiment, the wall forming the body 18 is approximately 1/16″ in thickness. The aperture 24 is typically ⅝″ in diameter to accommodate the typical size of a drill bit 36 or arbor of the hole saw 28. However, the aperture 24 can be of different diameters to accommodate drill bits, arbors and the like of different sizes. To accommodate standard hole saws 28 the inner diameter of the rim 20 is approximately 9″ across and the body 18 is approximately 4.5″ deep. The lip 22 is approximately 0.750″ in width and approximately 0.100″ thick. Such dimensions enable the device 10 to accommodate a number of different hole saws of different dimensions while also providing sufficient dimensions to capture dust and debris therein. Of course, it will be appreciated by those skilled in the art that the device 10 may be larger or smaller in size depending upon the requirements of the user and the size of the hole saws 28 placed therein.

The devices 10-16 of the present invention are typically formed by conventional molding techniques, such as injection-mold processes. The devices 10-16 are comprised of a material which is resiliently flexible so as to be pushed towards the working surface and returned to its natural state after the hole is completed, as will be described more fully herein. The devices 10-16 are preferably comprised of a material which does not scratch or mar the working surface. Preferably, the device 10-16 is transparent or translucent to enable the trade person to view the area to be cut. A particularly preferred material is UVA vinyl acetate, which has these characteristics.

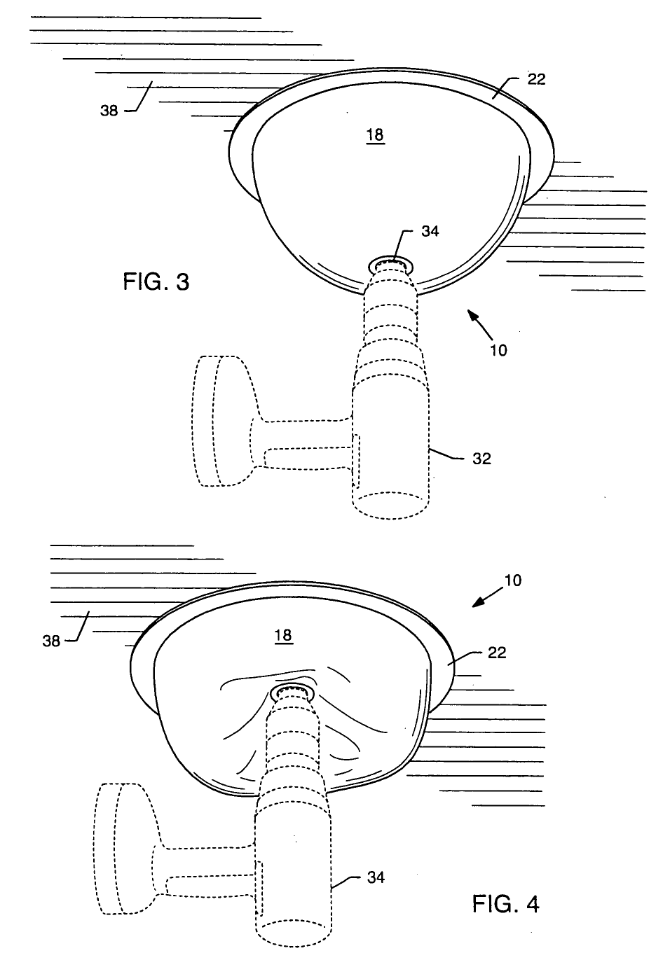

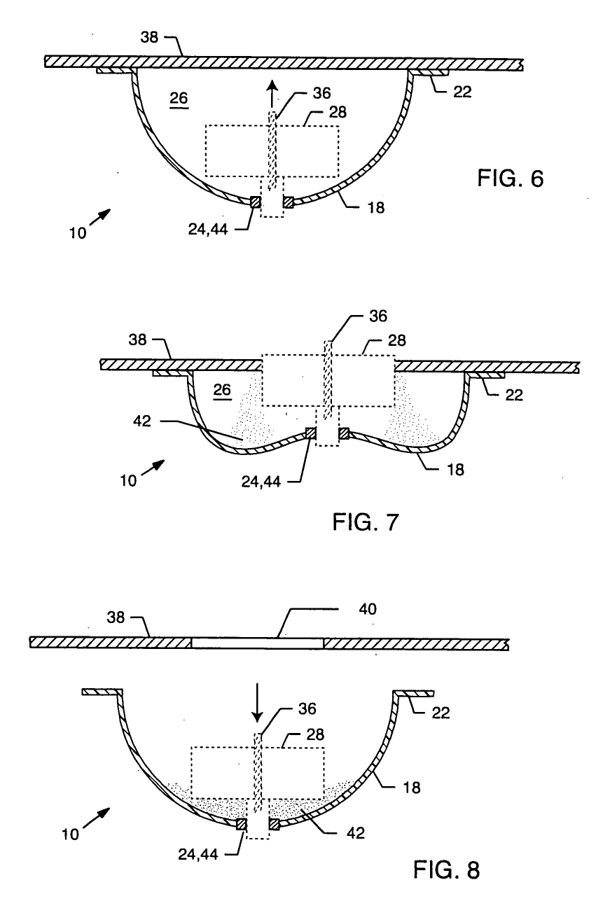

In use, as illustrated in FIGS. 3-5, the drill bit 36 or hole saw arbor is extended through the aperture 24 of the device 10. The pilot drill bit 36 and hole saw 28 are connected to the chuck 34 in traditional fashion. The device 10 is then placed against a working surface 38, such as the illustrated ceiling. Preferably, the lip or flange 22 rests generally flush against the working surface 38, as illustrated in FIG. 6.

The trades person then cuts the hole 40 in the working surface 38 by pushing the drill 34 upwardly, causing the hole saw 28 to cut into the working surface 38 to create the desired hole, as illustrated in FIGS. 4 and 7. It will be noted that the body 18 deforms in response to the upward pressure applied to the drill 34 and hole saw 28. Dust and debris 42 created during the cutting of the hole 40 falls into the internal cavity 26 of the device and is trapped there. The lip 22 prevents dust and debris from escaping around the upper edge of the device 10. This allows the trades person to eliminate all or virtually all of the cleaning preparation in a finished home or business. The lip 22 keeps the circumference of the device 10 constant, such as keeping it round, and flush with respect to the working surface 38.

Once the hole 40 is created, the drill 30 and hole saw 28 are then pulled away from the working surface 38, the debris 42 being contained within the internal cavity 26 of the device 10. The reader will note that due to the resiliently flexible qualities of the body 18, the device 10 returns to its normal state. The lip 22 also facilitates the return of the device 10 to its at rest and original shape.

It will be appreciated by those skilled in the art that a particularly advantageous characteristic of the device 10 is the “plunging” action thereof. That is, as the hole saw 28 or other cutting tool is pressed against the cutting surface 38, the wall defining the body 18 can deform and fully plunge so that the bottom of the body 18 reaches the same level as the rim 20, if necessary, so as to completely cut through the working material 38. This enables the trade person to cut much deeper than previous debris catchers. Also, it enables the trade person to have the normal “feel” of cutting. Also, the device 10 prevents the trade person from “punching through” once the hole is cut, possibly damaging wiring or other structures immediately above or behind the working surface 38.

Electricians, plumbers, or any other trade person will greatly appreciate the easy collection and disposal of the debris by the device 10 of the present invention during the cutting process. The device 10 works with a wide variety of cutting tools and drill bits used for cutting practically any material. When working with wood and plastic, the chips created are trapped inside the device 10 and are permitted from scattering and falling on the floor or in the face of the trade person. When using masony bits in concrete or a hole saw in drywall or plaster, the high RPM of these cutting tools will create a dust cloud without the present invention. However, the device 10 contains this dust cloud inside its cavity 26, thus providing safety and eliminating the need for clean-up. Additionally, the device 10 of the present invention offers safety protection for the user of the device 10.

Due to the “plunging action” used in the procedure of cutting holes with the present invention, and the force applied to the area of the body 18 surrounding aperture 24, it is possible that the aperture 24 could be undesirably enlarged or cracks formed therefrom. Accordingly, it is contemplated that the aperture 24 be reinforced by appropriate means 44. Such means, as illustrated in FIGS. 6-8, preferably comprises a metal washer grommet fastened about the aperture 24. Alternative means could comprise increasing the thickness of the wall defining the body 18 surrounding the aperture 24. Alternatively, a plastic washer or disk could be adhered to the body 18 surrounding the aperture 24. Another solution would be to provide a metal or plastic washer which would rest between the drill's chuck 34 and the body 18 surrounding the aperture 24.

With reference now to FIGS. 9 and 10, holes 40 in a working surface 38 are sometimes required in a corner of a room. Accordingly, the invention contemplates a design specifically for holes formed near a corner 46. The flange or lip 22 would define a generally triangular circumference from which the dome-shaped body 18 would extend. The triangular configuration would enable the device 12 to be inserted tightly into a corner and a hole 40 cut within either a wall or ceiling of the corner 46 to within an inch or so of the actual corner 46.

With reference now to FIGS. 11 and 12, in certain applications, longer drill bits and hole saws and cutting tools are necessary. Thus, the dome-shaped body 18 would be elongated such that the device 14 would have a generally open-ended cone configuration. The internal cavity 26 of this device 14 would accommodate the longer cutting tools while performing in the same manner as described above. Of course, it will be appreciated by those skilled in the art that the actual shape of the device 10-16 is not as critical as the benefits it provides due to the resiliently flexible material used to construct the device 10-16 and the ceiling lip 22 for capturing the dust and debris particles within the internal cavity 26 of the device 10-16.

With reference now to FIGS. 13-14, there are instances when removal of the debris 42 during or immediately after the cutting process is desirable. For example, when drilling or cutting through a relatively thick material, the debris 42 may be desirably removed from the internal cavity 26 of the device 10-16 so as not to fill the internal cavity 26 or impede the movement of the cutting tool 28. To accommodate this, a vacuum port 48 having a detachable lid 50 can be molded or otherwise attached to the body 18. As illustrated in FIG. 14, a vacuum line or hose 52 could be connected to the vacuum port 48 and used to remove the debris 42 from the internal cavity 26 either during or immediately after the cutting process. Such may be particularly advantageous when cutting dangerous materials such as asbestos-based materials. Some materials also produce a large amount of dust during the cutting process, thus impeding the visibility of the cutting tool 28. Removal of the debris dust 42 through a vacuum hose 22 connected to the vacuum port 48 enables the trade person to continue to view the cutting process. Alternatively, with the lid 50 in place, the device is used in normal fashion.

Although several embodiments have been described in detail for purposes of illustration, various modifications may be made without departing from the scope and spirit of the invention. Accordingly, the invention is not to be limited, except as by the appended claims.

What is claimed is:

1. A debris catching device for use in association with a cutting or abrasion tool connected to a power apparatus, the device comprising:
a resiliently flexible body having an upper rim adapted to rest generally flush with a working surface and defining an open-ended cavity configured to substantially surround the tool; and,
an aperture formed through the body generally opposite the opening of the cavity and configured to receive a portion of the power apparatus or tool therethrough;
whereby as the working surface is cut, debris is captured within the cavity of the body.

2. The device of claim 1, wherein the body is generally dome-shaped.

3. The device of claim 2, wherein the body is generally hemispherical.

4. The device of claim 2, wherein the body is generally an open-ended cone.

5. The device of claim 1, including a lip extending outwardly from the rim.

6. The device of claim 1, wherein the body is comprised of a non-marking material.

7. The device of claim 1, wherein the body is comprised of a transparent or translucent material.

8. The device of claim 1, wherein the body is comprised of UVA vinyl acetate.

9. The device of claim 1, including aperture reinforcement means.

10. The device of claim 1, including a vacuum port formed in the body configured for removable connection to a vacuum hose.

11. A debris catching device for hole saw apparatuses having a hole saw connected to a chuck of a drill, the device comprising:
a generally dome-shaped body comprised of a resiliently flexible material and having an upper rim adapted to rest generally flush with a working surface and defining an open-ended cavity configured to substantially surround the hole saw;
a lip extending outwardly from the upper rim; and
an aperture formed through the body generally opposite the opening of the cavity and configured to receive a drill bit or arbor of the hole saw apparatus therethrough;
whereby as a hole is cut through the working surface with the hole saw, debris is captured within the cavity of the body.

12. The device of claim 11, wherein the body is generally hemispherical.

13. The device of claim 11, wherein the body is generally an open-ended cone.

14. The device of claim 11, wherein the body is comprised of a non-marking material.

15. The device of claim 11, wherein the body is comprised of a transparent or translucent material.

16. The device of claim 11, wherein the body is comprised of UVA vinyl acetate.

17. The device of claim 11, including aperture reinforcement means.

18. The device of claim 11, including a vacuum port formed in the body configured for removable connection to a vacuum hose.

19. A debris catching device for hole saw apparatuses having a hole saw connected to a chuck of a drill, the device comprising:
a generally hemispherical body comprised of a resiliently flexible, non-marking and transparent or translucent material and having an upper rim adapted to rest generally flush with a working surface and defining an open-ended cavity configured to substantially surround the hole saw;
a lip extending outwardly from the upper rim; and
an aperture formed through the body generally opposite the opening of the cavity and configured to receive a drill bit or arbor of the hole saw apparatus therethrough;
whereby as a hole is cut through the working surface with the hole saw, debris is captured within the cavity of the body.

20. The device of claim 19, wherein the body is comprised of UVA vinyl acetate.

21. The device of claim 19, including aperture reinforcement means.

22. The device of claim 19, including a vacuum port formed in the body configured for removable connection to a vacuum hose.
